(19) United States
(12) Patent Application Publication
(10) Pub. No.: US 2003/0185622 A1
(43) Pub. Date: Oct. 2, 2003

(54) Coupling unit for a head tube of a bicycle

(76) Inventor: Ching-Yuan Wang, Taichung Hsien (TW)

Correspondence Address: CANTOR COLBURN LLP, 55 Griffin Road South, Bloomfield, CT, 06002, US

(21) Appl. No.: 10/142,285

(22) Filed: May 9, 2002

(30) Foreign Application Priority Data
Mar. 31, 2002 (TW) 091202971

(51) Int. Cl. B25G 3/00

(52) U.S. Cl. 403/305

(57) ABSTRACT

A coupling unit for a bicycle head tube of includes a hollow bowl, and a bearing received in the bowl and having an annular inner wall that is indented to form an annular step. The annular step has an annular riser with a riser face that extends axially of the annular inner wall, and an annular tread with a tread face that extends radially and inwardly from the riser face. A cap has annular upper and lower flanges. The upper flange is disposed over the annular inner wall of the bearing. The lower flange radially reduces from the upper flange and extends fittingly into the bearing. The lower flange has an annular peripheral wall face that complements and that is in face-to-face contact with the riser face, and an annular bottom end face that extends radially and inwardly from the peripheral wall face and that complements and that is in face-to-face contact with the tread face.

### BACKGROUND OF THE INVENTION

1. Field of the Invention

This invention relates to a coupling unit for a head tube of a bicycle.

2. Description of the Related Art

FIG. 1 illustrates a conventional coupling unit for a head tube 3. The coupling unit includes a bearing 1 mounted in one end of the head tube 3, and a cap 2 mounted on the bearing 1. The bearing 1 has an inner wall that is formed with a truncated conical inner face 101. The cap 2 includes a flange that extends into the bearing 1 and that has a truncated conical outer face 201 that complements and that is in face-to-face contact with the conical inner face 101. The conventional coupling unit is disadvantageous in that coaxial alignment of the cap 2 and the bearing 1 is difficult to achieve due to the tendency of the cap 2 to incline relative to the bearing 1 and that wobbling of the cap 2 on the bearing 1 tends to occur when the bicycle is in use. Moreover, dust and moisture tend to enter into the bearing 1 via a gap between the cap 2 and the bearing 1.

### SUMMARY OF THE INVENTION

Therefore, the object of the present invention is to provide a coupling unit that is adapted to be connected to a head tube of a bicycle and that is capable of overcoming the aforesaid drawbacks.

According to the present invention, there is provided a coupling unit that is adapted to be connected to a head tube of a bicycle and that comprises: a hollow bowl having annular top and bottom flanges, the top flange defining a bearing-receiving space, the bottom flange radially reducing from and cooperating with the top flange to define an annular shoulder therebetween, the bottom flange being adapted to be fittingly inserted into the head tube; a bearing fittingly received in the bearing-receiving space, seated on the shoulder, and having an annular inner wall that defines a cap-receiving space and that has a top end which is indented to form an annular step, the annular step having an annular riser with a riser face that extends axially of the annular inner wall, and an annular tread with a tread face that extends radially and inwardly from the riser face; and a cap having annular upper and lower flanges, the upper flange being disposed over the top end of the annular inner wall of the bearing, the lower flange radially reducing from the upper flange and extending fittingly into the cap-receiving space, the lower flange having an annular peripheral wall face that complements and that is in face-to-face contact with the riser face, and an annular bottom end face that extends radially and inwardly from the peripheral wall face and that complements and that is in face-to-face contact with the tread face.

### BRIEF DESCRIPTION OF THE DRAWINGS

In drawings which illustrate an embodiment of the invention,

FIG. 1 is a sectional view to illustrate how a conventional coupling unit is connected to a head tube of a bicycle;

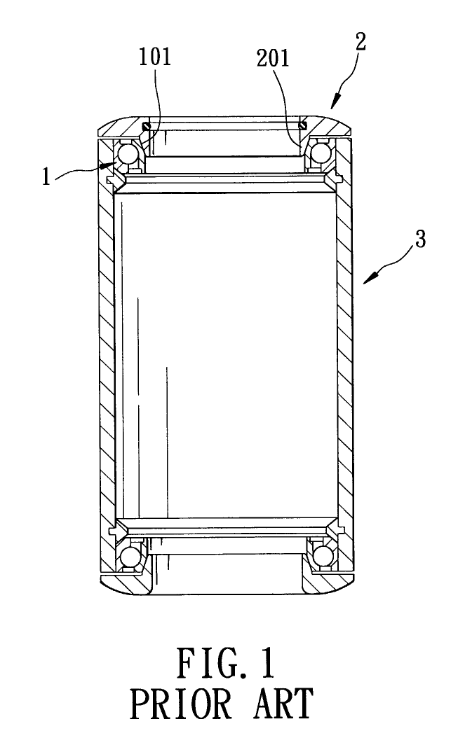

FIG. 2 is an exploded perspective view of a coupling unit embodying this invention for connecting with a head tube of a bicycle;

FIG. 3 is an exploded sectional view of the coupling unit and the head tube of FIG. 2; and

FIG. 4 is a sectional view to illustrate how the coupling unit of FIG. 2 is connected to the head tube.

### DETAILED DESCRIPTION OF THE PREFERRED EMBODIMENT

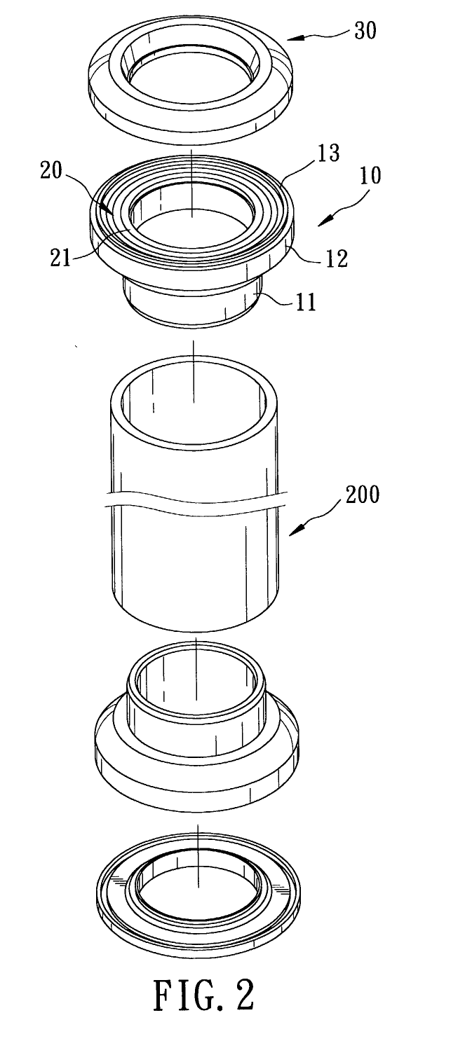

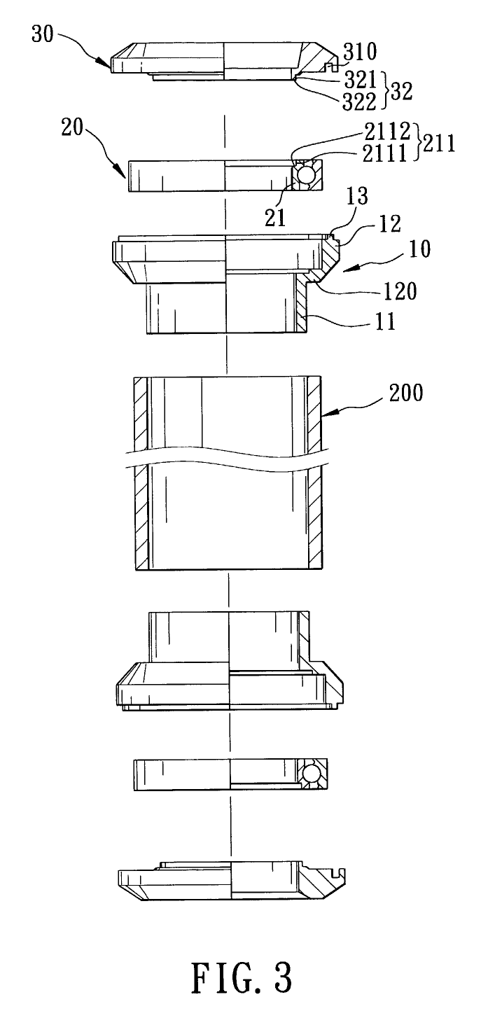

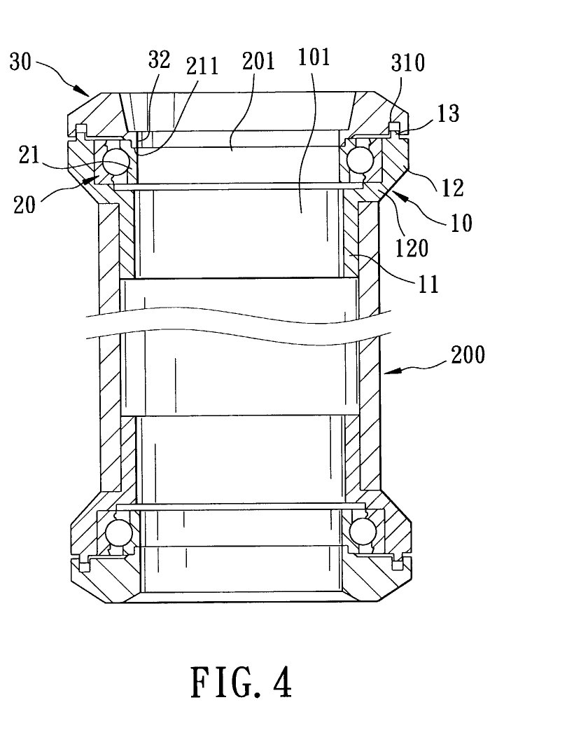

FIGS. 2 to 4 illustrate the preferred embodiment of a coupling unit of this invention for a head tube 200 of a bicycle (not shown).

The coupling unit includes: a hollow bowl 10 having annular top and bottom flanges 12, 11, the top flange 12 defining a bearing-receiving space 101, the bottom flange 11 radially reducing from and cooperating with the top flange 12 to define an annular shoulder 120 therebetween, the bottom flange 11 being fittingly inserted into one end of the head tube 200; a bearing 20 fittingly received in the bearing-receiving space 101, seated on an inner face of the shoulder 120, and having an annular inner wall 21 that defines a cap-receiving space 201 and that has a top end which is indented to form an annular step 211, the annular step 211 having an annular riser with a riser face 2111 that extends axially of the annular inner wall 21, and an annular tread with a tread face 2112 that extends radially and inwardly from the riser face 2111; and a cap 30 having annular upper and lower flanges 31, 32. The upper flange 31 is disposed over the top end of the annular inner wall 21 of the bearing 20. The lower flange 32 radially reduces from the upper flange 31 and extends fittingly into the cap-receiving space 201. The lower flange 32 has an annular peripheral wall face 321 that complements and that is in face-to-face contact with the riser face 2111, and an annular bottom end face 322 that extends radially and inwardly from the peripheral wall face 321 and that complements and that is in face-to-face contact with the tread face 2112 so as to limit radial movement of the cap 30 on the bearing 20 and so as to prevent inclining of the cap 30 relative to the bearing 20.

The upper flange 31 of the cap 30 has a bottom end face that is formed with an annular groove 310. The top flange 12 of the bowl 10 has a top end face, and an annular tongue 13 that projects from the top end face and that engages the annular groove 310 so as to prevent dust and moisture from entering into the bearing 1.

With the invention thus explained, it is apparent that various modifications and variations can be made without departing from the spirit of the present invention. It is therefore intended that the invention be limited only as recited in the appended claims.

I claim:

1. A coupling unit adapted to be connected to a head tube of a bicycle, said coupling unit comprising:
a hollow bowl having annular top and bottom flanges, said top flange defining a bearing-receiving space, said bottom flange radially reducing from and cooperating with said top flange to define an annular shoulder therebetween, said bottom flange being adapted to be fittingly inserted into the head tube;
a bearing fittingly received in said bearing-receiving space, seated on said shoulder, and having an annular inner wall that defines a cap-receiving space and that has a top end which is indented to form an annular step, said annular step having an annular riser with a riser face that extends axially of said annular inner wall, and an annular tread with a tread face that extends radially and inwardly from said riser face; and
a cap having annular upper and lower flanges, said upper flange being disposed over said top end of said annular inner wall of said bearing, said lower flange radially reducing from said upper flange and extending fittingly into said cap-receiving space, said lower flange having an annular peripheral wall face that complements and that is in face-to-face contact with said riser face, and an annular bottom end face that extends radially and inwardly from said peripheral wall face and that complements and that is in face-to-face contact with said tread face.

2. The coupling unit of claim 1, wherein said upper flange of said cap has a bottom end face that is formed with an annular groove, said top flange of said bowl having a top end face, and an annular tongue that projects from said top end face and that engages said annular groove.
